(19) United States
(12) Patent Application Publication
(10) Pub. No.: US 2026/0186544 A1
(43) Pub. Date: Jul. 2, 2026

(54) SERVER MANAGEMENT ENGINE RECOVERY CIRCUIT

(71) Applicant: SUZHOU METABRAIN INTELLIGENT TECHNOLOGY CO., LTD., Suzhou, Jiangsu (CN)

(72) Inventors: Yeyuan HE, Suzhou, Jiangsu (CN); Hui LIU, Suzhou, Jiangsu (CN); Shilin LI, Suzhou, Jiangsu (CN)

(21) Appl. No.: 19/470,768

(22) PCT Filed: May 27, 2024
(86) PCT No.: PCT/CN2024/095601

§ 371 Date: Mar. 17, 2026

(30) Foreign Application Priority Data
Jan. 30, 2024 (CN) 202410129353.5

(51) Int. Cl. G06F 1/24; G06F 1/28

(52) U.S. Cl. CPC G06F 1/24; G06F 1/28

(57) ABSTRACT

The embodiments of the present application provide a restoring circuit for a server managing engine. An integrated controlling module, when the server managing engine malfunctions, converts a high-level general-purpose-input-output signal into a low level and sends the low level to a baseboard management controller, whereby the baseboard management controller can send instruction information to a power-supply managing module, to instruct to firstly power off and subsequently power on the integrated controlling module. The power-supply managing module, after has received the instruction information, may send a powering-off enabling signal to a first power-supply protecting chip, and after the first power-supply protecting chip has stopped supplying electric power to the integrated controlling module, send a powering-on enabling signal to the first power-supply protecting chip, to realize firstly powering off and subsequently powering on the integrated controlling module. In the present application, the powering-off and powering-on of the integrated controlling module is realized directly by controlling the power-supply managing module, and it is not required to firstly power off and subsequently power on the general alternating-current power supply of the server, which reduces the difficulty and the cost in the operation and maintenance for the user.

### CROSS-REFERENCE TO RELATED APPLICATION

The present application claims the priority of the Chinese patent application filed on Jan. 30, 2024 before the Chinese Patent Office with the application number of 202410129353.5 and the title of “SERVER MANAGEMENT ENGINE RECOVERY CIRCUIT”, which is incorporated herein in its entirety by reference.

### FIELD

The present application relates to the field of computers, and particularly relates to a restoring circuit for a server managing engine.

### BACKGROUND

Servers are the core component of the industries such as big data and cloud computing. With the continuous development of the industries such as big data and cloud computing, the users are having higher requirements on the stability, the failure recoverability and the maintainability of the servers. With the conventional design of the electric-power supplying structure of the chips of the servers, when the integrated controlling module has a failure of the managing engine and it is required to perform an operation of powering-off and powering-on to the integrated controlling module, the general alternating-current power supply of the server must be firstly powered off and subsequently powered on in site before the failure can be recovered. Such a mode of failure recovery highly increases the difficulty and the cost in the operation and maintenance of the user.

### SUMMARY

In view of the above problems, the embodiments of the present application are proposed to provide a restoring circuit for a server managing engine that can overcome the above problems or at least partially solve the above problems.

In order to solve the above problems, the present application discloses a restoring circuit for a server managing engine, wherein the restoring circuit comprises an electric-power supplying module, a first power-supply protecting chip, a power-supply managing module, a baseboard management controller and an integrated controlling module;
an output terminal of the electric-power supplying module is connected to a first terminal of the first power-supply protecting chip and a first terminal of the power-supply managing module, and the electric-power supplying module is configured for converting an alternating voltage into a direct voltage and inputting the direct voltage into the first power-supply protecting chip and the power-supply managing module;
a second terminal of the power-supply managing module is connected to a first terminal of the baseboard management controller, a third terminal of the power-supply managing module is connected to a second terminal of the first power-supply protecting chip, and the power-supply managing module is configured for, after has received instruction information, sending a powering-off enabling signal to the first power-supply protecting chip, and after the first power-supply protecting chip has stopped supplying electric power to the integrated controlling module, sending a powering-on enabling signal to the first power-supply protecting chip;
a second terminal of the baseboard management controller is connected to an output terminal of the integrated controlling module, and the baseboard management controller is configured for, after has received a low-level general-purpose-input-output signal sent by the integrated controlling module, sending the instruction information to the power-supply managing module, wherein the instruction information is for instructing to firstly power off and subsequently power on the integrated controlling module;
a third terminal of the first power-supply protecting chip is connected to a power-supply inputting terminal of the baseboard management controller and a power-supply inputting terminal of the integrated controlling module, and the first power-supply protecting chip is configured for converting the direct voltage into a target voltage to supply electric power to the integrated controlling module and/or the baseboard management controller, after has received the powering-off enabling signal, stopping supplying electric power to the integrated controlling module, and after has received the powering-on enabling signal, supplying electric power to the integrated controlling module again; and
the integrated controlling module is configured for, in response to the server managing engine malfunctioning, converting a high-level general-purpose-input-output signal into the low-level general-purpose-input-output signal and sending the low-level general-purpose-input-output signal to the baseboard management controller.

In some embodiments, the baseboard management controller is configured for, after has received the low-level general-purpose-input-output signal sent by the integrated controlling module, sending an alarming signal and a powering-off request to a user terminal, and after has received a permission instruction sent by the user terminal, sending the instruction information to the power-supply managing module, wherein the instruction information is for instructing to firstly power off and subsequently power on the integrated controlling module.

In some embodiments, the baseboard management controller is configured for, after has received the low-level general-purpose-input-output signal sent by the integrated controlling module, sending an alarming signal to a user terminal, and sending the instruction information to the power-supply managing module, wherein the instruction information is for instructing to firstly power off and subsequently power on the integrated controlling module.

In some embodiments, the baseboard management controller is further configured for sending the alarming signal to the user terminal, timing, and after a timed time has reached a first preset time, sending the instruction information to the power-supply managing module.

In some embodiments, the baseboard management controller comprises a first timer, and the baseboard management controller is further configured for, when sending the alarming signal to the user terminal, controlling the first timer to time, and after the timed time of the first timer has reached the first preset time, sending the instruction information to the power-supply managing module.

In some embodiments, the restoring circuit for a server managing engine further comprises a first resistor and a second resistor; and one terminal of the first resistor is connected to the output terminal of the electric-power supplying module, the other terminal of the first resistor is connected to one terminal of the second resistor and an input terminal of the power-supply managing module, and the other terminal of the second resistor is earthed.

In some embodiments, the power-supply managing module comprises a second power-supply protecting chip and a complex programmable logic device, a first terminal of the second power-supply protecting chip is connected to the output terminal of the electric-power supplying module, a second terminal of the second power-supply protecting chip is connected to the other terminal of the first resistor, a third terminal of the second power-supply protecting chip is connected to a first terminal of the complex programmable logic device, and the second power-supply protecting chip is configured for detecting a first electric-current value that is inputted, and after the first electric-current value has reached a first preset threshold, stopping supplying electric power to the complex programmable logic device.

In some embodiments, the power-supply managing module further comprises a first voltage converting module, and the first voltage converting module is configured for converting the direct voltage into a first target voltage value and inputting the direct voltage of the first target voltage value into the complex programmable logic device.

In some embodiments, a second terminal of the complex programmable logic device is connected to the first terminal of the baseboard management controller, a third terminal of the complex programmable logic device is connected to the second terminal of the first power-supply protecting chip, and the complex programmable logic device is configured for, after has received the instruction information, sending the powering-off enabling signal to the first power-supply protecting chip, and after the first power-supply protecting chip has stopped supplying electric power to the integrated controlling module, sending the powering-on enabling signal to the first power-supply protecting chip.

In some embodiments, the complex programmable logic device is further configured for, after has received the instruction information, sending the powering-off enabling signal to the first power-supply protecting chip, after the first power-supply protecting chip has stopping supplying electric power to the integrated controlling module, timing, and after the timed time has reached a second preset time, sending the powering-on enabling signal to the first power-supply protecting chip.

In some embodiments, the complex programmable logic device comprises a second timer, and the complex programmable logic device is further configured for, after the first power-supply protecting chip has stopping supplying electric power to the integrated controlling module, controlling the second timer to time, and after a timed time of the second timer has reached the second preset time, sending the powering-on enabling signal to the first power-supply protecting chip.

In some embodiments, the restoring circuit further comprises a second voltage converting module, an input terminal of the second voltage converting module is connected to the third terminal of the first power-supply protecting chip, an output terminal of the second voltage converting module is connected to the power-supply inputting terminal of the baseboard management controller and the power-supply inputting terminal of the integrated controlling module, and the second voltage converting module is configured for converting the direct voltage into a second target voltage value and inputting the direct voltage of the second target voltage value into the baseboard management controller and the integrated controlling module.

In some embodiments, the restoring circuit further comprises a third voltage converting module, an input terminal of the third voltage converting module is connected to the third terminal of the first power-supply protecting chip, an output terminal of the third voltage converting module is connected to the power-supply inputting terminal of the baseboard management controller, and the third voltage converting module is configured for converting the direct voltage into a third target voltage value and inputting the direct voltage of the third target voltage value into the baseboard management controller.

In some embodiments, the first power-supply protecting chip is further configured for detecting a second electric-current value that is inputted, and after the second electric-current value has reached a second preset threshold, stopping supplying electric power to the baseboard management controller and the integrated controlling module.

In some embodiments, the second terminal of the power-supply managing module and the first terminal of the baseboard management controller are connected by a two-wire-type serial bus.

The embodiments of the present application have the following advantages:

The present application discloses a restoring circuit for a server managing engine. The integrated controlling module, when the server managing engine malfunctions, may convert the high-level general-purpose-input-output signal into a low level and send the low level to the baseboard management controller, whereby the baseboard management controller can send the instruction information to the power-supply managing module, to instruct to firstly power off and subsequently power on the integrated controlling module. The power-supply managing module, after has received the instruction information, may send the powering-off enabling signal to the first power-supply protecting chip, and after the first power-supply protecting chip has stopped supplying electric power to the integrated controlling module, send the powering-on enabling signal to the first power-supply protecting chip, to realize firstly powering off and subsequently powering on the integrated controlling module. In the present application, the powering-off and powering-on of the integrated controlling module may be realized directly by controlling the power-supply managing module, and it is not required to firstly power off and subsequently power on the general alternating-current power supply of the server, which reduces the difficulty and the cost in the operation and maintenance for the user.

### BRIEF DESCRIPTION OF THE DRAWINGS

FIG. 1 is a structural block diagram of a restoring circuit for a server managing engine according to an embodiment of the present application;

FIG. 2 is a structural block diagram of another restoring circuit for a server managing engine according to an embodiment of the present application;

FIG. 3 is a structural block diagram of another restoring circuit for a server managing engine according to an embodiment of the present application; and

FIG. 4 is a structural block diagram of another restoring circuit for a server managing engine according to an embodiment of the present application.

### DETAILED DESCRIPTION

In order to make the above purposes, features and advantages of the present application more apparent and understandable, the present application will be described in further detail below with reference to the drawings and the particular embodiments.

In the related art, when the integrated controlling module has a failure of the ME (Management Engine) and it is required to perform an operation of powering-off and powering-on to the chip of the integrated controlling module, the general alternating-current power supply of the server must be firstly powered off and subsequently powered on in site before the failure can be recovered. Such a mode of failure recovery highly increases the difficulty and the cost in the operation and maintenance of the user.

One of the core concepts of the embodiments of the present application is as follows. An integrated controlling module, when the server managing engine malfunctions, may convert a high-level general-purpose-input-output signal into a low level and send the low level to a baseboard management controller, whereby the baseboard management controller can send instruction information to a power-supply managing module, to instruct to firstly power off and subsequently power on the integrated controlling module. The power-supply managing module, after has received the instruction information, may send a powering-off enabling signal to a first power-supply protecting chip, and after the first power-supply protecting chip has stopped supplying electric power to the integrated controlling module, send a powering-on enabling signal to the first power-supply protecting chip, to realize firstly powering off and subsequently powering on the integrated controlling module. In the present application, the powering-off and powering-on of the integrated controlling module may be realized directly by controlling the power-supply managing module, and it is not required to firstly power off and subsequently power on the general alternating-current power supply of the server, which reduces the difficulty and the cost in the operation and maintenance for the user.

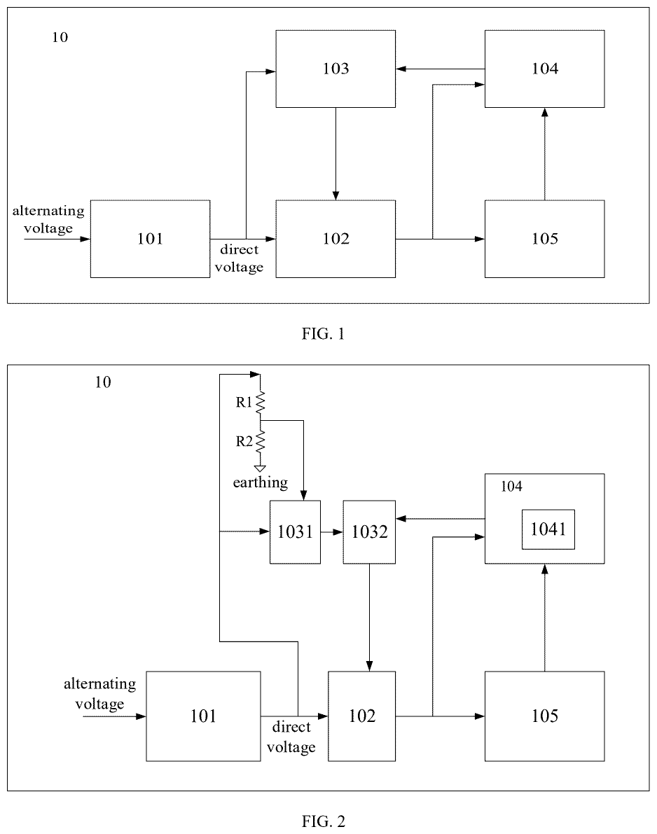

Referring to FIG. 1, FIG. 1 shows a structural block diagram of a restoring circuit for a server managing engine 10 according to an embodiment of the present application. The restoring circuit for a server managing engine comprises an electric-power supplying module 101, a first power-supply protecting chip 102, a power-supply managing module 103, a baseboard management controller 104 and an integrated controlling module 105.

The integrated controlling module 105 is configured for, in response to the server managing engine malfunctioning, converting a high-level general-purpose-input-output signal into the low-level general-purpose-input-output signal and sending the low-level general-purpose-input-output signal to the baseboard management controller 104.

In the embodiments of the present application, the managing engine refers to a microprocessor in an Intel server platform that is independent of the central processing unit and the operating system, and is integrated inside the integrated controlling module. In the servers developed based on the Intel platform, the failures in the managing engine are commonly seen failures. When such failures happen, the integrated controlling module must be firstly powered off and subsequently powered on before the failures can be recovered. Therefore, when the managing engine malfunctions, the integrated controlling module 105 may convert a high-level GPIO (General Purpose Input Output, general-purpose-input-output signal) signal into a low-level general-purpose-input-output signal and send the low-level general-purpose-input-output signal to the baseboard management controller 104.

The output terminal of the electric-power supplying module 101 is connected to a first terminal of the first power-supply protecting chip 102 and a first terminal of the power-supply managing module 103, and the electric-power supplying module 101 is configured for converting an alternating voltage into a direct voltage and inputting the direct voltage into the first power-supply protecting chip 102 and the power-supply managing module 103.

In the embodiments of the present application, the electric-power supplying module 101 may convert the alternating voltage that is inputted into the direct voltage of 12V, and subsequently input the direct voltage of 12V into the first power-supply protecting chip 102 and the power-supply managing module 103, to supply an input of a direct-current power supply for the first power-supply protecting chip 102 and the power-supply managing module 103.

A second terminal of the power-supply managing module 103 is connected to a first terminal of the baseboard management controller 104, a third terminal of the power-supply managing module 103 is connected to a second terminal of the first power-supply protecting chip 102, and the power-supply managing module 103 is configured for, after has received instruction information, sending a powering-off enabling signal to the first power-supply protecting chip 102, and after the first power-supply protecting chip 102 has stopped supplying electric power to the integrated controlling module 105, sending a powering-on enabling signal to the first power-supply protecting chip 102.

In the embodiments of the present application, the instruction information is for instructing to firstly power off and subsequently power on the integrated controlling module 105. The power-supply managing module 103, after has received the instruction information, may send the powering-off enabling signal to the first power-supply protecting chip 102, whereby the first power-supply protecting chip 102, after has received the powering-off enabling signal, stops supplying electric power to the integrated controlling module 105, to realize the powering-off of the integrated controlling module 105. Additionally, after the first power-supply protecting chip 102 has stopped supplying electric power to the integrated controlling module 105, the power-supply managing module 103 may send the powering-on enabling signal to the first power-supply protecting chip 102. The first power-supply protecting chip 102, after has received the powering-on enabling signal, may be restarted to supply electric power to the integrated controlling module 105, to realize the powering-on to the integrated controlling module.

A second terminal of the baseboard management controller 104 is connected to the output terminal of the integrated controlling module 105, and the baseboard management controller 104 is configured for, after has received a low-level general-purpose-input-output signal sent by the integrated controlling module 105, sending the instruction information to the power-supply managing module 103, wherein the instruction information is for instructing to firstly power off and subsequently power on the integrated controlling module 105.

In the embodiments of the present application, the baseboard management controller is used for the functions in the server system such as management, failure monitoring and alarming, network service supplying and fan controlling. The baseboard management controller 104 may, after has received the low-level general-purpose-input-output signal sent by the integrated controlling module 105, send the instruction information to the power-supply managing module 103, to instruct the power-supply managing module 103 to firstly power off and subsequently power on the integrated controlling module 105.

A third terminal of the first power-supply protecting chip 102 is connected to the power-supply inputting terminal of the baseboard management controller 104 and the power-supply inputting terminal of the integrated controlling module 105, and the first power-supply protecting chip 102 is configured for converting the direct voltage into a target voltage to supply electric power to the integrated controlling module and/or the baseboard management controller, after has received the powering-off enabling signal, stopping supplying electric power to the integrated controlling module 105, and after has received the powering-on enabling signal, supplying electric power to the integrated controlling module 105 again.

The present application discloses a restoring circuit for a server managing engine. The integrated controlling module, when the server managing engine malfunctions, may convert the high-level general-purpose-input-output signal into a low level and send the low level to the baseboard management controller, whereby the baseboard management controller can send the instruction information to the power-supply managing module, to instruct to firstly power off and subsequently power on the integrated controlling module. The power-supply managing module, after has received the instruction information, may send the powering-off enabling signal to the first power-supply protecting chip, and after the first power-supply protecting chip has stopped supplying electric power to the integrated controlling module, send the powering-on enabling signal to the first power-supply protecting chip, to realize firstly powering off and subsequently powering on the integrated controlling module. In the present application, the powering-off and powering-on of the integrated controlling module may be realized directly by controlling the power-supply managing module, and it is not required to firstly power off and subsequently power on the general alternating-current power supply of the server, which reduces the difficulty and the cost in the operation and maintenance for the user.

Referring to FIG. 2, FIG. 2 shows a structural block diagram of a restoring circuit for a server managing engine 10 according to an embodiment of the present application. The restoring circuit for a server managing engine comprises an electric-power supplying module 101, a first power-supply protecting chip 102, a power-supply managing module 103, a baseboard management controller 104 and an integrated controlling module 105.

The baseboard management controller 104 is configured for, after has received the low-level general-purpose-input-output signal sent by the integrated controlling module 105, sending an alarming signal and a powering-off request to a user terminal, and after has received a permission instruction sent by the user terminal, sending the instruction information to the power-supply managing module 103, wherein the instruction information is for instructing to firstly power off and subsequently power on the integrated controlling module.

In an embodiment of the present application, the baseboard management controller 104, after has received the low-level general-purpose-input-output signal sent by the integrated controlling module 105, may send an alarming signal to the user terminal, to alert the user that the managing engine malfunctions. Simultaneously with the sending of the alarming signal, it may send a powering-off request to the user terminal, wherein the powering-off request is for requesting to power off the integrated controlling module 105. After the user terminal has received the powering-off request, the user may decide whether to perform the powering-off operation to the integrated controlling module 105. If the user does not permit to perform the powering-off operation to the integrated controlling module 105, then the user may send a rejection instruction to the baseboard management controller 104 by using the user terminal, in which case the baseboard management controller 104 does not send the instruction information to the power-supply managing module 103. If the user permits to perform the powering-off operation to the integrated controlling module 105, then the user may send a permission instruction to the baseboard management controller 104 by using the user terminal, in which case the baseboard management controller 104, after has received the permission instruction, may send the instruction information to the power-supply managing module 103, to instruct to firstly power off and subsequently power on the integrated controlling module 105.

In some embodiments of the present application, the baseboard management controller 104 is configured for, after has received the low-level general-purpose-input-output signal sent by the integrated controlling module 105, sending an alarming signal to a user terminal, and sending the instruction information to the power-supply managing module 103, wherein the instruction information is for instructing to firstly power off and subsequently power on the integrated controlling module.

In an embodiment of the present application, the baseboard management controller 104, after has received the low-level general-purpose-input-output signal sent by the integrated controlling module 105, may send an alarming signal to the user terminal, and may simultaneously send the instruction information to the power-supply managing module 103, to instruct to firstly power off and subsequently power on the integrated controlling module 105.

In some embodiments of the present application, the baseboard management controller 104 is further configured for sending the alarming signal to the user terminal, timing, and after a timed time has reached a first preset time, sending the instruction information to the power-supply managing module 103.

In an embodiment of the present application, the baseboard management controller 104, when sending the alarming signal to the user terminal, may simultaneously time, and, merely when the timed time has reached the first preset time, send the instruction information to the power-supply managing module 103. In some examples, the first preset time is 10 s. In other words, the baseboard management controller 104, when sending the alarming signal to the user terminal, when the timed time reaches 10 s, may send the instruction information to the power-supply managing module 103.

It should be noted that the first preset time may be set according to the demand of the user, and is not limited herein.

In some embodiments of the present application, the baseboard management controller 104 comprises a first timer 1041, and the baseboard management controller 104 is further configured for, when sending the alarming signal to the user terminal, controlling the first timer 1041 to time, and after the timed time of the first timer has reached the first preset time, sending the instruction information to the power-supply managing module 103.

In an embodiment of the present application, as shown in FIG. 2, the baseboard management controller may further comprise a first timer 1041. The baseboard management controller 104, when sending the alarming signal to the user terminal, may control the first timer 1041 to time, and after the timed time of the first timer 1041 has reached the first preset time, may send the instruction information to the power-supply managing module 103.

In some embodiments of the present application, the restoring circuit for a server managing engine further comprises a first resistor R1 and a second resistor R2. One terminal of the first resistor R1 is connected to the output terminal of the electric-power supplying module 101, the other terminal of the first resistor R1 is connected to one terminal of the second resistor R2 and the input terminal of the power-supply managing module 103, and the other terminal of the second resistor R2 is earthed.

In an embodiment of the present application, as shown in FIG. 2, the restoring circuit for a server managing engine may further comprise a first resistor R1 and a second resistor R2, one terminal of the first resistor R1 is connected to the output terminal of the electric-power supplying module 101, the other terminal of the first resistor R1 is connected to one terminal of the second resistor R2 and the input terminal of the power-supply managing module 103, and the other terminal of the second resistor R2 is earthed. In the present application, the first resistor R1 and the second resistor R2 may divide a direct-current power supply outputted by the electric-power supplying module 101 into the enabling signals of the power-supply managing module 103, to ensure that, when the electric-power supplying module 101 is normally outputting the direct-current power supply, the power-supply managing module 103 is in the on-state.

In some embodiments of the present application, the power-supply managing module 103 comprises a second power-supply protecting chip 1031 and a complex programmable logic device 1032, a first terminal of the second power-supply protecting chip 1031 is connected to the output terminal of the electric-power supplying module 101, a second terminal of the second power-supply protecting chip 1031 is connected to the other terminal of the first resistor R1, a third terminal of the second power-supply protecting chip 1031 is connected to a first terminal of the complex programmable logic device 1032, and the second power-supply protecting chip 1031 is configured for detecting a first electric-current value that is inputted, and after the first electric-current value has reached a first preset threshold, stopping supplying electric power to the complex programmable logic device 1032, so as to provide the function of overcurrent protection.

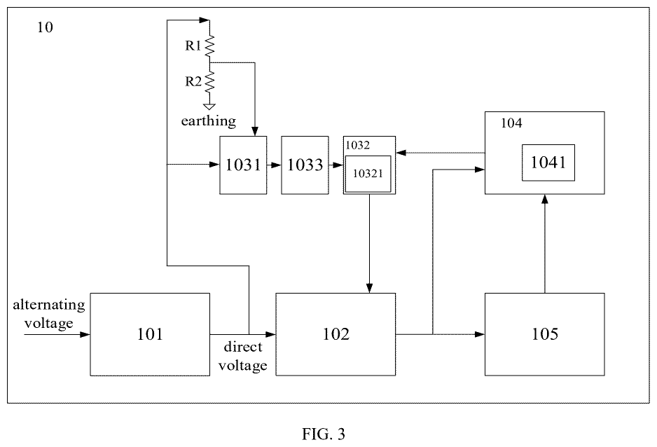

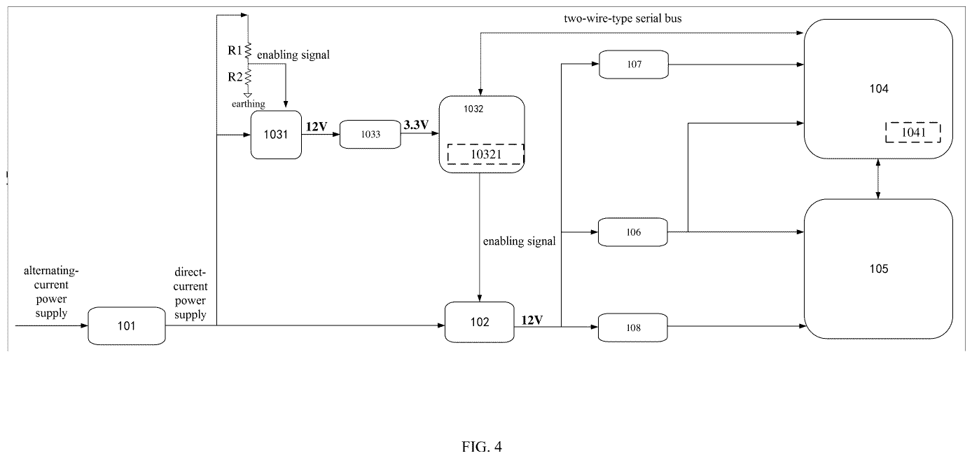

In some embodiments of the present application, the power-supply managing module 103 further comprises a first voltage converting module 1033, and the first voltage converting module 1033 is configured for converting the direct voltage into a first target voltage value and inputting the direct voltage of the first target voltage value into the complex programmable logic device 1032. Particularly, referring to FIG. 3, FIG. 3 shows a structural block diagram of another restoring circuit for a server managing engine 10 according to an embodiment of the present application. The power-supply managing module 103 further comprises a first voltage converting module 1033, the input terminal of the first voltage converting module 1033 is connected to the output terminal of the second power-supply protecting chip 1031, and the output terminal of the first voltage converting module 1033 is connected to the input terminal of the complex programmable logic device 1032. In some examples, the first voltage converting module 1033 may convert the direct voltage of 12V into 3.3V, to supply electric power of 3.3V to the complex programmable logic device 1032.

In some embodiments of the present application, a second terminal of the complex programmable logic device 1032 is connected to the first terminal of the baseboard management controller 104, a third terminal of the complex programmable logic device 1032 is connected to the second terminal of the first power-supply protecting chip 102, and the complex programmable logic device 1032 is configured for, after has received the instruction information, sending the powering-off enabling signal to the first power-supply protecting chip 102, and after the first power-supply protecting chip 102 has stopped supplying electric power to the integrated controlling module 105, sending the powering-on enabling signal to the first power-supply protecting chip 102.

In some embodiments of the present application, the complex programmable logic device 1032 is further configured for, after has received the instruction information, sending the powering-off enabling signal to the first power-supply protecting chip 102, after the first power-supply protecting chip 102 has stopping supplying electric power to the integrated controlling module, timing, and after the timed time has reached a second preset time, sending the powering-on enabling signal to the first power-supply protecting chip 102, to cause the first power-supply protecting chip 102 to supply electric power to the integrated controlling module 105 again.

In some embodiments of the present application, the complex programmable logic device 1032 comprises a second timer 10321, and the complex programmable logic device is further configured for, after the first power-supply protecting chip has stopping supplying electric power to the integrated controlling module, controlling the second timer 10321 to time, and after a timed time of the second timer has reached the second preset time, sending the powering-on enabling signal to the first power-supply protecting chip.

It should be noted that the second preset time may be set according to the demand of the user, which is not limited herein.

In some embodiments of the present application, the restoring circuit for a server managing engine further comprises a second voltage converting module, the input terminal of the second voltage converting module is connected to the third terminal of the first power-supply protecting chip, the output terminal of the second voltage converting module is connected to the power-supply inputting terminal of the baseboard management controller and the power-supply inputting terminal of the integrated controlling module, and the second voltage converting module is configured for converting the direct voltage into a second target voltage value and inputting the direct voltage of the second target voltage value into the baseboard management controller and the integrated controlling module.

As shown in FIG. 4, FIG. 4 shows a structural block diagram of another restoring circuit for a server managing engine according to an embodiment of the present application. The restoring circuit for a server managing engine further comprises a second voltage converting module 106, as the second voltage converting module 106 in the figure. The second voltage converting module 106 may be a 3.3V VR (Voltage Regulator, voltage converting module), and the 3.3V voltage converting module may convert the direct voltage of 12V into the direct voltage of 3.3V and input the direct voltage of 3.3V into the baseboard management controller 104 and the integrated controlling module 105.

The second voltage converting module 106 may also be a 1.8V voltage converting module, which may convert the direct voltage of 12V into the direct voltage of 1.8V and input the direct voltage of 1.8V into the baseboard management controller 104 and the integrated controlling module 105.

In some embodiments of the present application, the restoring circuit for a server managing engine further comprises a third voltage converting module 107, the input terminal of the third voltage converting module 107 is connected to the third terminal of the first power-supply protecting chip 102, the output terminal of the third voltage converting module 107 is connected to the power-supply inputting terminal of the baseboard management controller 104, and the third voltage converting module 107 is configured for converting the direct voltage into a third target voltage value and inputting the direct voltage of the third target voltage value into the baseboard management controller.

In an embodiment of the present application, as shown in FIG. 4, the third voltage converting module 107 may comprise a 1.0V voltage converting module and a 1.2V voltage converting module, the 1.0V voltage converting module may convert the direct voltage of 12V into the direct voltage of 1.0V and input the direct voltage of 1.0V into the baseboard management controller 104, and the 1.2V voltage converting module may convert the direct voltage of 12V into the direct voltage of 1.2V and input the direct voltage of 1.2V into the baseboard management controller 104.

In some embodiments of the present application, the restoring circuit for a server managing engine may further comprise a fourth voltage converting module 108, the fourth voltage converting module 108 may comprise a 1.05V voltage converting module, the input terminal of the fourth voltage converting module 108 is connected to the third terminal of the first power-supply protecting chip 102, the output terminal of the fourth voltage converting module 108 is connected to the power-supply inputting terminal of the integrated controlling module 105, and the 1.05V voltage converting module may convert the direct voltage of 12V into the direct voltage of 1.05V and input the direct voltage of 1.05V into the integrated controlling module 105.

In some embodiments of the present application, the first power-supply protecting chip 102 is further configured for detecting a second electric-current value that is inputted, and after the second electric-current value has reached a second preset threshold, stopping supplying electric power to the baseboard management controller 104 and the integrated controlling module 105.

In an embodiment of the present application, the first power-supply protecting chip 102 is further configured for detecting a second electric-current value that is inputted, and after the second electric-current value has reached a second preset threshold, stopping supplying electric power to the baseboard management controller 104 and the integrated controlling module 105, so as to reach the effect of overcurrent protection.

In some embodiments of the present application, the second terminal of the power-supply managing module 103 and the first terminal of the baseboard management controller 104 are connected by a two-wire-type serial bus.

In an embodiment of the present application, the second terminal of the power-supply managing module 103 and the first terminal of the baseboard management controller 104 are connected by an I2C (Inter-Integrated Circuit, two-wire-type serial bus) bus.

The present application discloses a restoring circuit for a server managing engine. The integrated controlling module, when the server managing engine malfunctions, may convert the high-level general-purpose-input-output signal into a low level and send the low level to the baseboard management controller, whereby the baseboard management controller can send the instruction information to the power-supply managing module, to instruct to firstly power off and subsequently power on the integrated controlling module. The power-supply managing module, after has received the instruction information, may send the powering-off enabling signal to the first power-supply protecting chip, and after the first power-supply protecting chip has stopped supplying electric power to the integrated controlling module, send the powering-on enabling signal to the first power-supply protecting chip, to realize firstly powering off and subsequently powering on the integrated controlling module. In the present application, the powering-off and powering-on of the integrated controlling module may be realized directly by controlling the power-supply managing module, and it is not required to firstly power off and subsequently power on the general alternating-current power supply of the server, which reduces the difficulty and the cost in the operation and maintenance for the user.

1. A restoring circuit for a server managing engine, wherein the restoring circuit comprises an electric-power supplying module, a first power-supply protecting chip, a power-supply managing module, a baseboard management controller and an integrated controlling module;
an output terminal of the electric-power supplying module is connected to a first terminal of the first power-supply protecting chip and a first terminal of the power-supply managing module, and the electric-power supplying module is configured for converting an alternating voltage into a direct voltage and inputting the direct voltage into the first power-supply protecting chip and the power-supply managing module;
a second terminal of the power-supply managing module is connected to a first terminal of the baseboard management controller, a third terminal of the power-supply managing module is connected to a second terminal of the first power-supply protecting chip, and the power-supply managing module is configured for, after has received instruction information, sending a powering-off enabling signal to the first power-supply protecting chip, and after the first power-supply protecting chip has stopped supplying electric power to the integrated controlling module, sending a powering-on enabling signal to the first power-supply protecting chip;
a second terminal of the baseboard management controller is connected to an output terminal of the integrated controlling module, and the baseboard management controller is configured for, after has received a low-level general-purpose-input-output signal sent by the integrated controlling module, sending the instruction information to the power-supply managing module, wherein the instruction information is for instructing to firstly power off and subsequently power on the integrated controlling module;
a third terminal of the first power-supply protecting chip is connected to a power-supply inputting terminal of the baseboard management controller and a power-supply inputting terminal of the integrated controlling module, and the first power-supply protecting chip is configured for converting the direct voltage into a target voltage to supply electric power to the integrated controlling module and/or the baseboard management controller, after has received the powering-off enabling signal, stopping supplying electric power to the integrated controlling module, and after has received the powering-on enabling signal, supplying electric power to the integrated controlling module again; and
the integrated controlling module is configured for, in response to the server managing engine malfunctioning, converting a high-level general-purpose-input-output signal into the low-level general-purpose-input-output signal and sending the low-level general-purpose-input-output signal to the baseboard management controller.

2. The restoring circuit for a server managing engine according to claim 1, wherein the baseboard management controller is configured for, after has received the low-level general-purpose-input-output signal sent by the integrated controlling module, sending an alarming signal and a powering-off request to a user terminal, and after has received a permission instruction sent by the user terminal, sending the instruction information to the power-supply managing module, wherein the instruction information is for instructing to firstly power off and subsequently power on the integrated controlling module.

3. The restoring circuit for a server managing engine according to claim 1, wherein the baseboard management controller is configured for, after has received the low-level general-purpose-input-output signal sent by the integrated controlling module, sending an alarming signal to a user terminal, and sending the instruction information to the power-supply managing module, wherein the instruction information is for instructing to firstly power off and subsequently power on the integrated controlling module.

4. The restoring circuit for a server managing engine according to claim 3, wherein the baseboard management controller is further configured for sending the alarming signal to the user terminal, timing, and after a timed time has reached a first preset time, sending the instruction information to the power-supply managing module.

5. The restoring circuit for a server managing engine according to claim 4, wherein the baseboard management controller comprises a first timer, and the baseboard management controller is further configured for, when sending the alarming signal to the user terminal, controlling the first timer to time, and after the timed time of the first timer has reached the first preset time, sending the instruction information to the power-supply managing module.

6. The restoring circuit for a server managing engine according to claim 1, wherein the restoring circuit for a server managing engine further comprises a first resistor and a second resistor; and
one terminal of the first resistor is connected to the output terminal of the electric-power supplying module, the other terminal of the first resistor is connected to one terminal of the second resistor and an input terminal of the power-supply managing module, and the other terminal of the second resistor is earthed.

7. The restoring circuit for a server managing engine according to claim 6, wherein the power-supply managing module comprises a second power-supply protecting chip and a complex programmable logic device, a first terminal of the second power-supply protecting chip is connected to the output terminal of the electric-power supplying module, a second terminal of the second power-supply protecting chip is connected to the other terminal of the first resistor, a third terminal of the second power-supply protecting chip is connected to a first terminal of the complex programmable logic device, and the second power-supply protecting chip is configured for detecting a first electric-current value that is inputted, and after the first electric-current value has reached a first preset threshold, stopping supplying electric power to the complex programmable logic device.

8. The restoring circuit for a server managing engine according to claim 7, wherein the power-supply managing module further comprises a first voltage converting module, and the first voltage converting module is configured for converting the direct voltage into a first target voltage value and inputting the direct voltage of the first target voltage value into the complex programmable logic device.

9. The restoring circuit for a server managing engine according to claim 8, wherein a second terminal of the complex programmable logic device is connected to the first terminal of the baseboard management controller, a third terminal of the complex programmable logic device is connected to the second terminal of the first power-supply protecting chip, and the complex programmable logic device is configured for, after has received the instruction information, sending the powering-off enabling signal to the first power-supply protecting chip, and after the first power-supply protecting chip has stopped supplying electric power to the integrated controlling module, sending the powering-on enabling signal to the first power-supply protecting chip.

10. The restoring circuit for a server managing engine according to claim 9, wherein the complex programmable logic device is further configured for, after has received the instruction information, sending the powering-off enabling signal to the first power-supply protecting chip, after the first power-supply protecting chip has stopping supplying electric power to the integrated controlling module, timing, and after the timed time has reached a second preset time, sending the powering-on enabling signal to the first power-supply protecting chip.

11. The restoring circuit for a server managing engine according to claim 10, wherein the complex programmable logic device comprises a second timer, and the complex programmable logic device is further configured for, after the first power-supply protecting chip has stopping supplying electric power to the integrated controlling module, controlling the second timer to time, and after a timed time of the second timer has reached the second preset time, sending the powering-on enabling signal to the first power-supply protecting chip.

12. The restoring circuit for a server managing engine according to claim 1, wherein the restoring circuit further comprises a second voltage converting module, an input terminal of the second voltage converting module is connected to the third terminal of the first power-supply protecting chip, an output terminal of the second voltage converting module is connected to the power-supply inputting terminal of the baseboard management controller and the power-supply inputting terminal of the integrated controlling module, and the second voltage converting module is configured for converting the direct voltage into a second target voltage value and inputting the direct voltage of the second target voltage value into the baseboard management controller and the integrated controlling module.

13. The restoring circuit for a server managing engine according to claim 1, wherein the restoring circuit further comprises a third voltage converting module, an input terminal of the third voltage converting module is connected to the third terminal of the first power-supply protecting chip, an output terminal of the third voltage converting module is connected to the power-supply inputting terminal of the baseboard management controller, and the third voltage converting module is configured for converting the direct voltage into a third target voltage value and inputting the direct voltage of the third target voltage value into the baseboard management controller.

14. The restoring circuit for a server managing engine according to claim 1, wherein the first power-supply protecting chip is further configured for detecting a second electric-current value that is inputted, and after the second electric-current value has reached a second preset threshold, stopping supplying electric power to the baseboard management controller and the integrated controlling module.

15. The restoring circuit for a server managing engine according to claim 1, wherein the second terminal of the power-supply managing module and the first terminal of the baseboard management controller are connected by a two-wire-type serial bus.

16. The restoring circuit for a server managing engine according to claim 1, wherein the step of converting the alternating voltage into the direct voltage and inputting the direct voltage into the first power-supply protecting chip and the power-supply managing module comprises:
converting the alternating voltage that is inputted into the direct voltage of 12V, and inputting the direct voltage into the first power-supply protecting chip and the power-supply managing module.

17. The restoring circuit for a server managing engine according to claim 6, wherein the first resistor and the second resistor divide a direct-current power supply outputted by the electric-power supplying module into the enabling signals of the power-supply managing module.

18. The restoring circuit for a server managing engine according to claim 8, wherein the step of converting the direct voltage into the first target voltage value and inputting the direct voltage of the first target voltage value into the complex programmable logic device comprises:
converting the direct voltage of 12V into 3.3V, and inputting the direct voltage into the complex programmable logic device, wherein an output terminal of the first voltage converting module is connected to an input terminal of the complex programmable logic device.

19. The restoring circuit for a server managing engine according to claim 13, wherein the third voltage converting module comprises a 1.0V voltage converting module and a 1.2V voltage converting module, the 1.0V voltage converting module is configured for converting the direct voltage of 12V into the direct voltage of 1.0V and inputting the direct voltage of 1.0V into the baseboard management controller, and the 1.2V voltage converting module is configured for converting the direct voltage of 12V into the direct voltage of 1.2V and inputting the direct voltage of 1.2V into the baseboard management controller.

20. The restoring circuit for a server managing engine according to claim 1, wherein the restoring circuit further comprises a fourth voltage converting module, an input terminal of the fourth voltage converting module is connected to the third terminal of the first power-supply protecting chip, an output terminal of the fourth voltage converting module is connected to the power-supply inputting terminal of the integrated controlling module, and the fourth voltage converting module is configured for converting the direct voltage and inputting the direct voltage into the integrated controlling module.
